(19) United States
(12) Patent Application Publication
(10) Pub. No.: US 2022/0136468 A1
(43) Pub. Date: May 5, 2022

(54) ENGINE CONTROL DEVICE

(71) Applicant: Mazda Motor Corporation, Aki-gun (JP)

(72) Inventors: Yasunori Matoba, Aki-gun (JP); Hiroyuki Morioka, Aki-gun (JP)

(21) Appl. No.: 17/452,352

(22) Filed: Oct. 26, 2021

(30) Foreign Application Priority Data
Nov. 5, 2020 (JP) 2020-185064

(51) Int. Cl. F02M 35/10; F02D 13/02; F02D 41/04; F01M 13/00; F01M 11/10

(52) U.S. Cl. CPC F02M 35/10308; F02D 13/0226; F02D 41/042; F01M 2250/00; F01M 11/10; F02M 35/10222; F02D 2200/70; F01M 13/00

(57) ABSTRACT

A device is provided, which controls a vehicle-mounted engine provided with an engine body with a plurality of cylinders, a plurality of independent intake passages, each connected to the engine body so as to communicate with a combustion chamber of each cylinder via an intake port, and a surge tank connected to an upstream end of each independent intake passage. The device includes a phase changer, an ambient temperature sensor, and a controller configured to acquire an amount of condensate water existing in the surge tank. When the engine is stopped in a situation where the ambient temperature is lower than a given reference temperature and the condensate water amount is above a given reference amount, the controller controls the phase changer so that a lift amount of an intake valve in each cylinder of the stopped engine becomes outside a given minute lift range.

### TECHNICAL FIELD

The present disclosure relates to a device which controls a vehicle-mounted engine provided with an engine body including a plurality of cylinders, a plurality of independent intake passages connected to the engine body so that each communicates with a combustion chamber of each cylinder via an intake port, and a surge tank to which an upstream end of each independent intake passage is connected.

### BACKGROUND OF THE DISCLOSURE

When vehicles are used in an environment where the ambient temperature is low, icing may occur in an intake valve or an exhaust valve (hereinafter, both are comprehensively referred to as valves) of an engine mounted on the vehicles. That is, after the engine is stopped, the temperature of the engine falls to the freezing point, and moisture adhered to a gap between the valve and a valve seat (valve gap) freezes to form ice. When such icing of the valve occurs, the ice existing in the valve gap may impede operation of the valve (making the valve difficult to fully close) at a restart of the engine to cause inconvenience, such as a misfire.

As an engine which can solve the above inconvenience, the following engine disclosed in JP2014-058217A is known. In detail, the engine disclosed in JP2014-058217A is provided with a motor generator coupled to an output shaft of the engine, and a control device (PCM) which controls the motor generator when the engine is stopped to adjust an opening of the valve (lift amount). The control device adjusts a torque given to the output shaft from the motor generator during an engine stop operation so that the output shaft stops at a position where the valve is fully closed or at a position where the valve gap becomes larger than a given minute amount.

According to the above configuration, since the engine stopping in a state where the minute valve gap remains is avoided (that is, the valve gap when the engine is stopped is set as zero or a large enough value), there is an advantage in that the moisture does not stagnate in the valve gap while the engine is stopped, and the inconvenience due to freezing of the moisture when the engine restarts can be solved.

However, in the above method disclosed in JP2014-058217A which controls the stop position of the output shaft at the desired position (the position where the valve gap does not become the minute amount), it is necessary to delicately adjust the torque given to the output shaft from the motor generator within a narrow range during the engine stop operation, thereby requiring a complicated and precise control. Therefore, instead of the method disclosed in JP2014-058217A (the method of adjusting the motor generator torque), it is possible to use a device which can change a phase of the valve (phase changer). That is, the phase of the valve with respect to the phase of the output shaft is corrected to an advancing or retarding side as needed by using the phase changer so that the valve gap while the engine is stopped does not become the minute amount. Note that since the icing of the valve more easily occurs at the intake valve than at the exhaust valve, such a phase change may be applied at least to the intake valve.

However, if the phase of the intake valve is corrected using the phase changer, the engine restartability may worsen because the corrected phase deviates from a phase suitable for restarting. For this reason, the phase of the intake valve may be corrected only in a required situation as much as possible to lessen the frequency of the correction.

### SUMMARY OF THE DISCLOSURE

The present disclosure is made in view of the above situations, and one purpose thereof is to provide a control device for an engine, capable of preventing icing of an intake valve, while suppressing an influence which affects restartability of the engine to a minimum.

According to one aspect of the present disclosure, a control device configured to control an engine mounted on a vehicle is provided, the engine being provided with an engine body including a plurality of cylinders, a plurality of independent intake passages, each connected to the engine body so as to communicate with a combustion chamber of each of the cylinders via an intake port, and a surge tank connected to an upstream end of each of the independent intake passages. The control device includes a phase changer configured to change a phase of an intake valve configured to open and close the intake port of each of the cylinders, an ambient temperature sensor configured to acquire an ambient temperature, and a controller configured to control operation of the phase changer and acquire an amount of condensate water existing in the surge tank. When the engine is stopped in a situation where both of a first condition in which the ambient temperature acquired by the ambient temperature sensor is lower than a given reference temperature and a second condition in which the amount of condensate water in the surge tank acquired by the controller is above a given reference amount are satisfied, the controller controls the phase changer so that a lift amount of the intake valve in each of the cylinders of the stopped engine becomes outside a given minute lift range.

When the condensate water amount in the surge tank is above the reference amount, since the condensate water easily flows from the surge tank to the intake port, there is a possibility that the flowed condensate water stagnates in a valve gap of the intake valve (a gap between an umbrella part of the intake valve and a valve seat). Furthermore, if such a stagnation of the condensate water in the valve gap occurs in a situation where the ambient temperature drops below the reference temperature, there is a possibility that the condensate water which stagnates in the valve gap becomes frozen to form ice (the intake valve freezes). On the contrary, according to this configuration, under the condition in which the icing of the intake valve may occur, that is, when both of the first condition in which the ambient temperature is below the reference temperature and the second condition in which the condensate water amount in the surge tank is above the reference amount are satisfied, the phase changer for the intake valve is controlled so that the lift amount of the intake valve is deviated from the minute lift range. Therefore, by reducing the valve gap to substantially zero or increasing it to the large enough value, the stagnation of the condensate water in the valve gap can be made difficult to occur, and the freezing of the condensate water in the valve gap (the icing of the intake valve) can be prevented. Thus, for example, it can be prevented that a malfunction of the intake valve occurs when the engine restarts, to secure a suitable engine reliability.

However, when the phase of the intake valve is changed, the opening-and-closing timings of the intake valve deviate from the timings suitable for the engine restart, and an influence such as lengthening the time required for restarting (a time from a cranking start to a completion of combustion) may occur. On the contrary, according to this configuration, since the correction of the phase of the intake valve becomes unnecessary if at least one of the first condition and the second condition described above is not satisfied, the frequency of the correction can be reduced as much as possible, and the influence on the engine restartability can be suppressed to a minimum.

Here, as the method of deviating the lift amount of the intake valve from the minute lift range, a method of adjusting the phase of the intake valve during an engine stop operation (from the ignition OFF to the complete stop of the engine) or a method of adjusting the phase of the intake valve after the engine is stopped (completely stopped), may be used. Note that the latter is more suitable for improving the accuracy of the adjustment of the lift amount because the phase can be adjusted (corrected) after confirming the lift amount of the intake valve at the timing of the engine stop. That is, when the engine is stopped, the controller may determine the first and second conditions, and determine a third condition in which the lift amount of the intake valve of any one of the cylinders is within the minute lift range, and when all the first to third conditions are satisfied, the controller may drive the phase changer to correct the phase of the intake valve to an advancing or retarding side so that the lift amount of the intake valve is deviated from the minute lift range in all the cylinders.

When the engine is stopped, the controller may determine the first to third conditions, and determine a fourth condition in which the vehicle is stopped in a state where the vehicle is inclined so that the surge tank is displaced upwardly, and when all the first to fourth conditions are satisfied, the controller may correct the intake valve by the phase changer.

Since the vehicle inclining in such a direction that the surge tank is displaced upwardly, promotes the outflow of the condensate water from the surge tank to the intake port, it increases the possibility of icing of the intake valve. On the contrary, the possibility of icing becomes lower if the vehicle is not inclined in such a direction. According to this configuration, the inclination state of the vehicle when the engine is stopped is also determined, and if the vehicle is not inclined in such a direction that the surge tank is displaced upwardly, the phase correction of the intake valve is not performed. Therefore, an unnecessary correction of the phase of the intake valve in the situation where the icing of the intake valve does not take place can highly possibly be avoided. Thus, the frequency of the correction can be lessened, and the influence on the engine restartability can be minimized.

The engine may be provided with a blowby gas passage connecting the engine body to the surge tank so that blowby gas leaked to a crankcase of the engine body flows back to the surge tank. The controller may estimate an oil-pan water amount that is an amount of condensate water contained in engine oil stored in an oil pan of the engine body, based on an operating state of the engine, estimate a water evaporating amount that is an amount of moisture evaporating from the engine oil, based on the estimated oil-pan water amount, and further estimate the amount of condensate water in the surge tank based on the estimated water evaporating amount.

According to this configuration, the condensate water amount in the surge tank can be calculated with high accuracy by the suitable calculation technique in consideration of the actual mechanism of the condensate water being accumulated in the surge tank with the blowby gas.

A lower limit of the minute lift range may be set to a value larger than zero and an upper limit of the minute lift range may be set to a value smaller than a maximum lift amount of the intake valve.

When a crank angle while the engine is stopped completely is an angle within a given section near an opening timing of the intake valve of an intake-stroke-stopped cylinder that is stopped in an intake stroke, the controller may correct the phase of the intake valve to an advancing side by a given correction amount to increase the lift amount of the intake valve of the intake-stroke-stopped cylinder to a value larger than the minute lift range.

When a crank angle while the engine is stopped completely is a given angle included in a given section near a closing timing of the intake valve of an intake-stroke-stopped cylinder that is stopped in an intake stroke, the controller may correct the phase of the intake valve to an advancing side by a given correction amount to decrease the lift amount of the intake valve of the intake-stroke-stopped cylinder to a substantially-zero value smaller than the minute lift range.

The water evaporating amount may be calculated based on the oil-pan water amount obtained in the previous operation cycle, and a temperature of the engine oil. The water evaporating amount may be calculated to be larger as the previous oil-pan water amount increases and calculated to be larger as the oil temperature increases.

### BRIEF DESCRIPTION OF DRAWINGS

FIG. 1 is a plan view schematically illustrating the entire configuration of an engine to which a control device according to one embodiment of the present disclosure is applied.

FIG. 2 is a side view schematically illustrating the engine.

FIG. 3 is a plan view schematically illustrating the entire configuration of a vehicle on which the engine is mounted.

FIG. 4 is a cross-sectional view illustrating more concrete shapes of an intake port, an independent intake passage, and a surge tank of the engine.

FIG. 5 is a block diagram illustrating a control system of the engine.

FIG. 6 is a flowchart illustrating a control operation executed when the engine is stopped.

FIG. 7 is a front view illustrating a state where the vehicle leans to the right.

FIG. 8 is a graph illustrating lift curves of an intake valve before and after a phase of the intake valve is corrected.

FIG. 9 is an enlarged cross-sectional view illustrating a valve gap of the intake valve.

### DETAILED DESCRIPTION OF THE DISCLOSURE

### (1) Overall Configuration of Engine

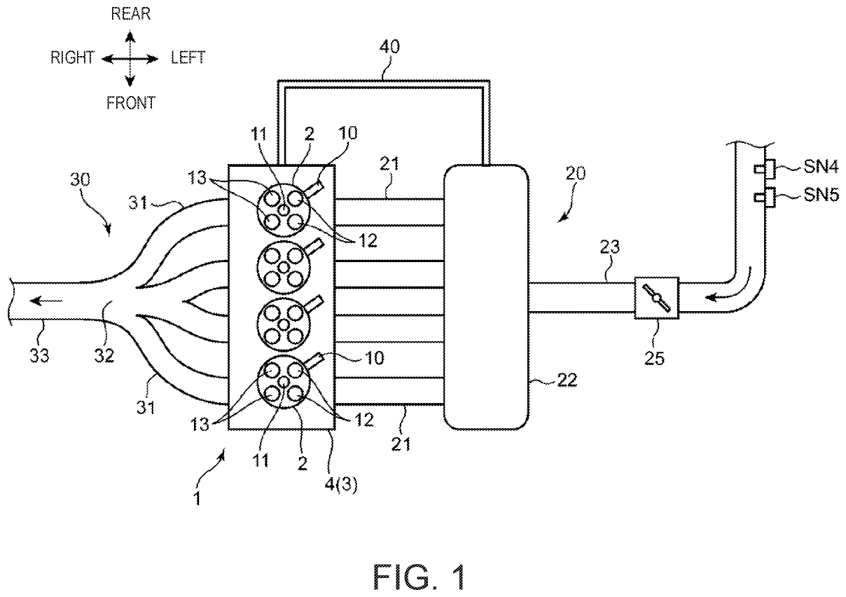

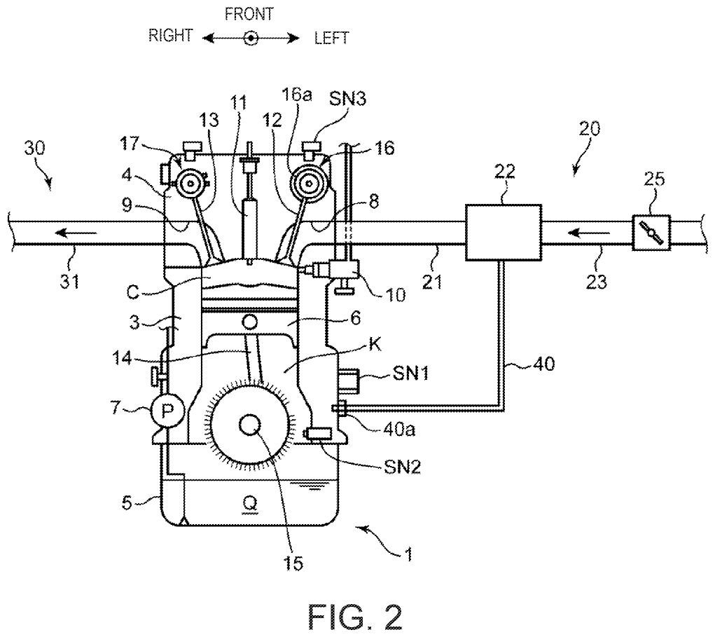

FIGS. 1 and 2 are views schematically illustrating the overall configuration of an engine to which a control device according to one embodiment of the present disclosure is applied. The engine illustrated in this figure is a four-cycle jump-spark-ignition type gasoline engine mounted on a vehicle, as a propelling power source. The engine is provided with an in-series multi-cylinder engine body 1 including a plurality of (here, four) cylinders 2 which are lined up, an intake passage 20 where intake air to be introduced into the engine body 1 circulates, and an exhaust passage 30 where exhaust gas discharged from the engine body 1 circulates.

As mainly illustrated in FIG. 2, the engine 1 is provided with a cylinder block 3 having the plurality of cylinders 2 therein, a cylinder head 4 attached to the cylinder block 3 from above, and an oil pan 5 attached to the cylinder block 3 from below.

A piston 6 (FIG. 2) is reciprocatably accommodated in each cylinder 2 of the engine body 1. A combustion chamber C which is a space for combusting fuel is formed above each piston 6.

A jacket part for circulating coolant for cooling wall surfaces of the combustion chambers C is formed inside the cylinder block 3. A water temperature sensor SN1 (FIG. 2) which detects the temperature of the coolant (engine water temperature) inside the jacket part is provided to the cylinder block 3.

Engine oil Q (FIG. 2) is stored in the oil pan 5. The engine oil Q is lubricating oil used for the purpose of lubricating sliding parts of the engine body 1. The engine oil Q is pumped up by an oil pump 7 and is supplied to each part of the engine body 1 via an oil gallery, etc.

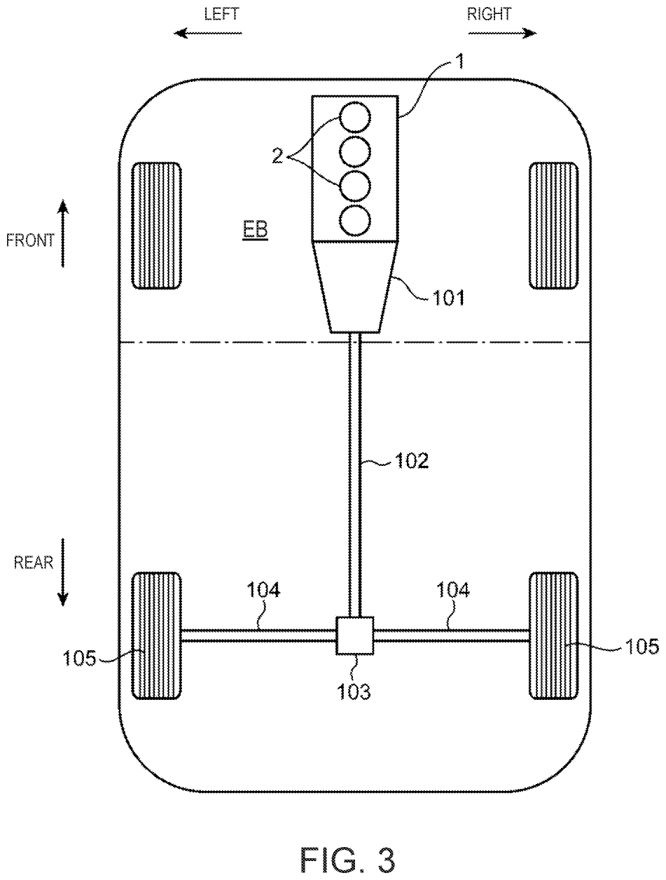

As illustrated in FIG. 3, the engine of this embodiment is mounted on the vehicle in a posture of so-referred to as “longitudinal mount.” That is, when the lined-up direction of the plurality of cylinders 2 in the engine body 1 is a “cylinder lined-up direction,” the engine is disposed inside an engine bay EB in a front part of the vehicle in a posture where the cylinder lined-up direction is in agreement with a vehicle front-and-rear direction.

Here, the vehicle illustrated in FIG. 3 is a rear-wheel-drive vehicle which transmits an output rotation of the engine to left and right rear wheels 105. That is, the vehicle includes a transmission 101 attached to a rear side of the engine body 1, a propeller shaft 102 extending rearwardly from the transmission 101, a differential 103 connected to a rear end of the propeller shaft 102, and a pair of left and right drive shafts 104 which extend to the left and right from the differential 103. The rear wheel 105 is attached to a tip-end part of each drive shaft 104. The output rotation of the engine body 1 is reduced by the transmission 101 and is then inputted into the differential 103 via the propeller shaft 102. The rotation inputted into the differential 103 is transmitted to the rear wheels 105 via the left and right drive shafts 104. Note that “front,” “rear,” “left,” and “right” described in FIGS. 1 and 2 are based on the vehicle illustrated in FIG. 3.

Returning to FIGS. 1 and 2, the description about the engine is continued. An injector 10, a spark plug 11, an intake valve 12, and an exhaust valve 13 are provided to each cylinder 2 of the engine body 1 (a part of the cylinder head 4 corresponding to each cylinder 2). The injector 10 is an injection valve which injects fuel containing gasoline to the combustion chamber C. The spark plug 11 is a plug which ignites an air-fuel mixture of fuel and air. The intake valve 12 is a valve which opens and closes an intake port 8 communicating the intake passage 20 (each independent intake passage 21 described later) with the combustion chamber C. The exhaust valve 13 is a valve which opens and closes an exhaust port 9 communicating the exhaust passage 30 (each independent exhaust passage 31 described later) with the combustion chamber C. Note that the valve type of the engine of this embodiment is a four-valve type comprised of two intake valves and two exhaust valves. That is, in this embodiment, two intake ports 8 and two exhaust ports 9 are formed to each cylinder 2, two intake valves 12 and two exhaust valves 13 are provided to each cylinder 2, corresponding to the numbers of ports 8 and 9.

The fuel supplied to the combustion chamber C from the injector 10 forms the air-fuel mixture by being mixed with air inside the combustion chamber C. The air-fuel mixture combusts, triggered by an ignition of the spark plug 11, and the piston 6 reciprocates in response to an expansion force of the combustion. The reciprocating motion of the piston 6 is transmitted to a crankshaft 15 which is the output shaft of the engine body 1 via a crank mechanism including a connecting rod 14, etc. to rotate the crankshaft 15. A crank angle sensor SN2 which detects a rotation angle (crank angle) and a rotational speed (engine speed) of the crankshaft 15 is provided to the cylinder block 3.

An intake valve operating mechanism 16 for opening and closing the intake valve 12 of each cylinder 2 and an exhaust valve operating mechanism 17 for opening and closing the exhaust valve 13 of each cylinder 2 are provided to the cylinder head 4. Each of the valve operating mechanisms 16 and 17 includes a camshaft which is interlockingly coupled to the crankshaft 15, and opens and closes the intake valve 12 or the exhaust valve 13 in an interlocking fashion with the rotation of the crankshaft 15.

An electrically-operated intake SVT 16a is built in the intake valve operating mechanism 16. The intake SVT 16a is a device which changes a rotation phase of the camshaft for the intake valve 12 (a phase of the intake valve 12) with respect to a rotation phase of the crankshaft 15, and changes an opening timing and a closing timing of the intake valve 12 by an equal amount while maintaining a lift amount and a valve opening period of the intake valve 12. Note that the camshaft which is changed in the phase by the intake SVT 16a is a camshaft common to all the cylinders 2. In other words, the intake SVT 16a changes the rotation phase of the camshaft to collectively change the opening and closing timings of the intake valve 12 of each cylinder 2. The intake SVT 16a is one example of a “phase changer” in the present disclosure.

A cam angle sensor SN3 for detecting a rotation angle of the camshaft included in the intake valve operating mechanism 16 is provided to the cylinder head 4. Information outputted from the cam angle sensor SN3 is used in combination with information outputted from the crank angle sensor SN2 described above, in order to perform a cylinder determination (which cylinder is in which stroke), an operational confirmation of the phase change of the intake valve 12 by the intake SVT 16a, etc.

The exhaust passage 30 has a plurality of (here, four) independent exhaust passages 31 connected to a right side surface of the engine body 1, a collecting part 32 where downstream end parts (the side away from the engine body 1) of the independent exhaust passages 31 are joined together, and a single-tubed common exhaust passage 33 extending downstream from the collecting part 32. Each independent exhaust passage 31 is connected to the engine body 1 so as to communicate with each cylinder 2 via the exhaust port 9.

The intake passage 20 has a plurality of (here, four) independent intake passages 21 connected to a left side surface of the engine body 1, a common surge tank 22 to which upstream end parts (the side away from the engine body 1) of the independent intake passages 21 are connected, and a single-tubed common intake passage 23 extending upstream from the surge tank 22. Each independent intake passage 21 is connected to the engine body 1 so as to communicate with the combustion chamber C of each cylinder 2 via the intake port 8.

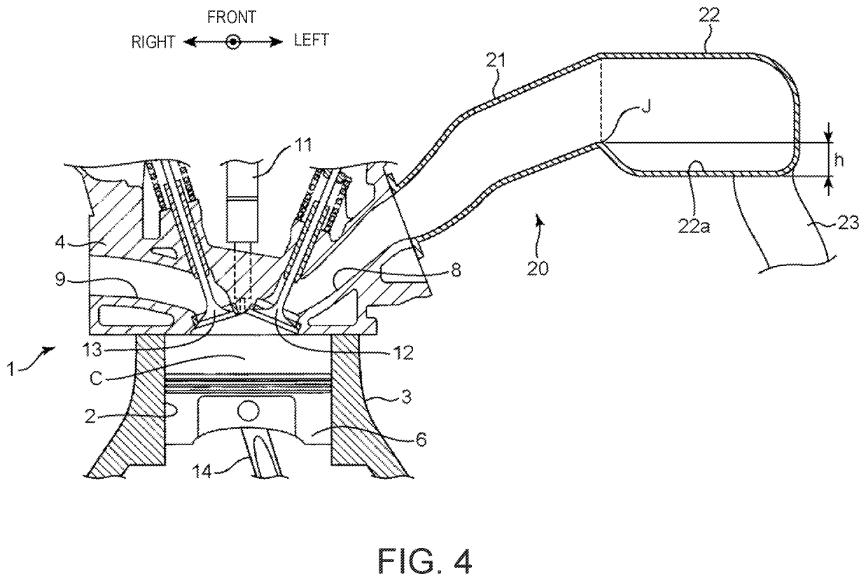

FIG. 4 is a cross-sectional view illustrating the shapes of the intake port 8, the independent intake passage 21, and the surge tank 22 more concretely (in a more realistic mode). As illustrated in this figure, the intake port 8 and the independent intake passage 21 constitute a series of passages which incline so that their heights become lower as they approach the combustion chamber C (toward the right). The surge tank 22 is formed so that its passage area is larger than the independent intake passage 21, and it is connected to an upstream end of the independent intake passage 21 from the left side. A bottom surface 22a of the surge tank 22 has a downwardly-dented shape, and its lowest part is lower than a connecting part J between the bottom surface 22a and the independent intake passage 21 by a given distance h. Note that the dented amount of the bottom surface 22a (distance h) is small, compared with surge tanks of conventional engines. This is because of the convenience of a layout in which an intake system component group (outside the drawing) located upstream of the surge tank 22 (for example, an intercooler) is disposed directly below the surge tank 22.

As illustrated in FIGS. 1 and 2, a blowby gas passage 40 extending from the engine body 1 (cylinder block 3) is connected to the surge tank 22. The blowby gas passage 40 is a passage for introducing into (flowing back to) the intake passage 20 blowby gas (mixed gas of unburnt fuel, air, and combusted gas) which is generated in the engine body 1. The blowby gas passage 40 communicates with a crankcase K which is a space below the piston 6 in the engine body 1 with an interior space of the surge tank 22, and has a function to recirculate to the surge tank 22 the blowby gas which passed through the crankcase K from the combustion chamber C.

A PCV valve 40a (FIG. 2) is provided to a connecting part between the blowby gas passage 40 and the engine body 1. The PCV valve 40a is a valve which opens only on a condition in which the pressure of the surge tank 22 is smaller than the pressure of the crankcase K by more than a given amount, and has a function to prevent a backflow of the blowby gas.

A throttle valve 25 which can open and close for adjusting an intake air flow rate is provided at an intermediate location of the common intake passage 23. Furthermore, an intake air temperature sensor SN4 which detects a temperature of intake air circulating in the common intake passage 23 and an air flow sensor SN5 which detects a flow rate of the intake air are provided in the common intake passage 23 at positions upstream of the throttle valve 25 (see FIG. 1). Note that the intake air temperature sensor SN4 is one example of an “ambient temperature sensor” in the present disclosure.

### (2) Control System

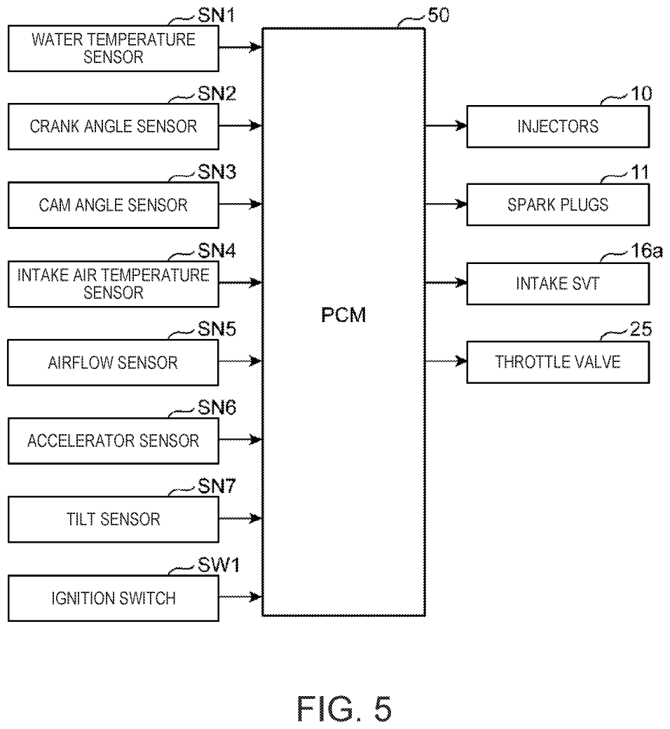

FIG. 5 is a block diagram illustrating a control system of the engine of this embodiment. A powertrain control module (PCM) 50 illustrated in this figure is a microcomputer for comprehensively controlling the engine, and is comprised of a processor (e.g., a central processing unit (CPU)), memory such as ROM and/or RAM, etc. which are well-known.

Detection information by various sensors is inputted into the PCM 50. For example, the PCM 50 is electrically coupled to the water temperature sensor SN1, the crank angle sensor SN2, the cam angle sensor SN3, the intake air temperature sensor SN4, and the air flow sensor SNS, which are described above. Information detected by these sensors (that is, information on the engine water temperature, the crank angle, the engine speed, the cam angle, the intake air temperature, the intake air flow rate, etc.) are sequentially inputted into the PCM 50.

Furthermore, an accelerator sensor SN6 which detects an opening of an accelerator pedal (accelerator opening) operated by a driver who operates the vehicle, and a tilt sensor SN7 which detects an inclining state of the vehicle are provided to the vehicle, and detection information by the accelerator sensor SN6 and the tilt sensor SN7 are also sequentially inputted into the PCM 50.

Furthermore, an ignition switch SW1 operated by the driver when starting or stopping the engine is provided to the vehicle, and the operation signal of the ignition switch SW1 is also inputted into the PCM 50.

The PCM 50 controls each part of the engine while performing various calculations and determinations based on the inputted information from the sensors and the switches (SN1-SN7 and SW1) which are described above. That is, the PCM 50 is electrically connected to the injector 10, the spark plug 11, the intake SVT 16a, and the throttle valve 25, and outputs a control signal to each apparatus based on the calculation results, etc. Note that the PCM 50 is an example of a “controller” in the present disclosure.

### (3) Control While Engine is Stopped

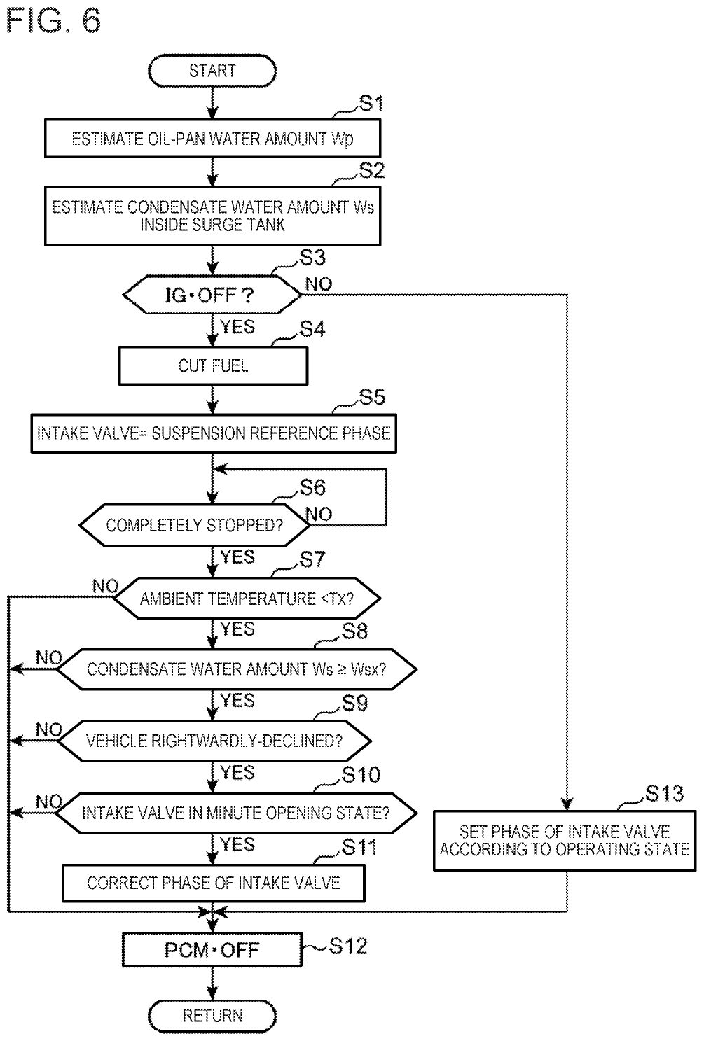

Next, a control operation executed by the PCM 50 when the engine is stopped is described using a flowchart of FIG. 6. As a premise to which the flowchart of FIG. 6 is applied, suppose that the ignition switch SW1 is in an ON state and the engine is under operation. When the control of the flowchart starts in response to the operation of the engine, the PCM 50 estimates an oil-pan water amount Wp which is an amount of condensate water which is contained in the engine oil Q inside the oil pan 5 (step S1). In detail, the PCM 50 calculates the oil-pan water amount Wp using Formula (1) below.

Wp(i)=Wp(i-1)+w1(i)−w2(i) (1)

Here, w1 is an amount of condensate water taken into the engine oil Q per unit time (an increasing amount of the condensate water in the engine oil Q per unit time), and, below, it is referred to as a “water increasing amount w1.” w2 is an amount of moisture which evaporates from the engine oil Q per unit time, and, below, it is referred to as a “water evaporating amount w2.” Description in the parenthesis attached to each symbol (Wp, w1, and w2), such as the oil-pan water amount, the water increasing amount, or the water evaporating amount, indicates an operation cycle, where “i” indicates the latest operation cycle, “i-1” indicates one operation cycle before the latest operation cycle.

From Formula (1), the oil-pan water amount Wp can be obtained by calculating a difference between the water increasing amount w1 and the water evaporating amount w2 for every operation cycle, and adding up the differences. That is, in each operation cycle, the PCM 50 calculates each time the difference (w1(i)-w2(i)) which is obtained by subtracting the water evaporating amount w2(i) from the water increasing amount w1(i), and calculates a current oil-pan water amount Wp(i) by adding the calculated difference to the oil-pan water amount Wp(i-1) calculated in the previous operation cycle.

Although the water increasing amount w1 and the water evaporating amount w2 can be calculated by various methods, the amounts w1 and w2 can be calculated by the following method, for example.

The water increasing amount w1 can be calculated based on an amount of blowby gas which leaks into the crankcase K (FIG. 2). For example, the PCM 50 calculates the amount of blowby gas which leaks into the crankcase K from the combustion chamber C per unit time based on an operating state (engine speed, load, etc.) of the engine at each time point. Then, based on an assumption that a given ratio of the moisture contained in the blowby gas is taken in as the condensate water in the engine oil Q, the water increasing amount w1 in the engine oil Q is calculated using a given equation. For example, the amount of blowby gas is multiplied by a given coefficient (for example, 0.075), an amount equivalent to moisture which remains in the crankcase K as water vapor (an amount equivalent to saturated water vapor) is subtracted from the multiplied value to calculate the water increasing amount w1.

The water evaporating amount w2 can be calculated based on the (previous) oil-pan water amount Wp(i-1) calculated in the previous operation cycle, and the temperature of the engine oil Q (hereinafter, referred to as an “oil temperature”). For example, the water evaporating amount w2 is calculated so that it becomes larger as the previous oil-pan water amount Wp(i-1) increases and as the oil temperature increases. Note that the oil temperature can be estimated from the temperature of the engine coolant detected by the water temperature sensor SN1, for example.

When the oil-pan water amount Wp is calculated as described above, the PCM 50 then calculates a condensate water amount Ws inside the surge tank 22 (step S2). The condensate water amount Ws is calculated based on that moisture (steam) introduced into the surge tank 22 through the blowby gas passage 40 from the crankcase K condenses inside the surge tank 22, and it is further accumulated as ice. For example, when the engine operates on a condition where the intake air temperature is very low (a condition of below a reference temperature Tx described later), it can be considered that, because the low-temperature intake air continuously circulates the surge tank 22, moisture freezes on an inner surface of the surge tank 22 (especially, the bottom surface 22a) to form ice, and the ice is accumulated with the engine operating time. At step S2, an amount of ice accumulated in the surge tank 22 based on such a premise is calculated as the condensate water amount Ws in the surge tank 22.

In detail, at step S2, the PCM 50 calculates the condensate water amount Ws using Formula (2) below.

Ws(i)=Ws(i-1)+w3(i) (2)

Here, w3 is an amount of ice formed in the surge tank 22 per unit time, and, below, it is referred to as a water freezing amount w3. Furthermore, similarly to Formula (1) described above, “i” or “i-1” in the parenthesis indicates the operation cycle.

From Formula (2), the condensate water amount Ws can be obtained by calculating the water freezing amount w3 for every operation cycle and adding up the water freezing amounts w3. That is, the PCM 50 calculates a current condensate water amount Ws(i) by calculating each time the water freezing amount w3 in each operation cycle, and adding the calculated water freezing amount w3 to the previous condensate water amount Ws(i-1) calculated in the previous operation cycle.

The water freezing amount w3 (an ice forming amount in the surge tank 22 per unit time) is calculated based on the water evaporating amount w2 which is used when calculating the oil-pan water amount Wp at step S1. For example, the PCM 50 calculates, as the water freezing amount w3, a value obtained by multiplying the water evaporating amount w2 from the engine oil Q per unit time by a first coefficient defined according to the temperature and a second coefficient defined based on the shape of the surge tank 22 (internal surface area, etc.). The first coefficient is set to a larger value as the temperature of intake air detected by the intake air temperature sensor SN4 (≈ambient temperature) decreases. The second coefficient is defined experimentally according to the shape of the surge tank 22.

When the condensate water amount Ws in the surge tank 22 is calculated as described above, the PCM 50 then determines whether the ignition switch SW1 is turned OFF based on the operation signal inputted from the ignition switch SW1 (step S3).

If determined to be NO at step S3 where the ignition switch SW1 is not turned OFF, the PCM 50 sets the phase of the intake valve 12 as a suitable phase according to the current operating state of the engine (load, engine speed, etc.) (step S13).

On the other hand, if determined to be YES at step S3 where the ignition switch SW1 is turned OFF, the PCM 50 suspends the fuel injection from the injector 10 (step S4), and sets the phase of the intake valve 12 as a suspension reference phase which is defined beforehand (step S5). Here, the suspension reference phase is defined in consideration of the startability of the stopped engine when it restarts (restartability). That is, at step S5, the phase of the intake valve 12 is set as such a phase that the intake valve 12 opens and closes at a timing suitable for combustion of the air-fuel mixture when the engine restarts.

Next, the PCM 50 determines, based on the detection value, etc. of the crank angle sensor SN2, whether the engine is stopped completely, that is, whether the rotation of the output shaft of and the engine body 1 (crankshaft 15) is stopped completely (step S6).

If determined to be YES at step S6 where the engine is stopped completely, the PCM 50 then determines whether the ambient temperature is below the reference temperature Tx determined beforehand, based on the detection value of the intake air temperature sensor SN4 (step S7). For example, the ambient temperature may be a temperature of intake air detected by the intake air temperature sensor SN4 when the ignition switch SW1 is turned OFF. Furthermore, the reference temperature Tx may be 0° C., for example.

If determined to be YES at step S7 where the ambient temperature is below the reference temperature Tx, the PCM 50 determines whether the condensate water amount Ws calculated at step S2 is above a reference amount Wsx determined beforehand (step S8). The reference amount Wsx is set as such a value that condensate water flows toward the independent intake passage 21 from the surge tank 22, when the same amount of condensate water is assumed to be accumulated at the bottom surface 22a (FIG. 4) of the surge tank 22. That is, if the condensate water amount Ws is below the reference amount Wsx, the condensate water is considered to remain in the depression of the bottom surface 22a even if the condensate water is accumulated at the bottom surface 22a of the surge tank 22, and the condensate water is considered not to flow into the independent intake passage 21 from the surge tank 22. On the other hand, if the condensate water amount Ws increases above the reference amount Wsx, the water level of the condensate water at the bottom surface 22a of the surge tank 22 may become as large as that the condensate water overflows from the surge tank 22 and begins to leak to the independent intake passage 21 (as a result, to the intake port 8 of each cylinder 2). From such a viewpoint, the reference amount Wsx is a value defined beforehand based on the shape, etc. of the surge tank 22.

Note that if the ambient temperature is below the reference temperature Tx (for example, 0° C.), the condensate water in the surge tank 22 may highly possibly exist as ice at least when the engine is stopped completely. For this reason, the condensate water amount Ws in the surge tank 22 being above the reference amount Wsx does not always lead to the leakage of the condensate water from the surge tank 22 (the inflow of the condensate water to the independent intake passage 21 and the intake port 8). However, after the engine is stopped, the temperature of the engine bay EB increases due to the heat release from the engine parts which are increased in the temperature by heat of combustion and exhaust gas before the stop, and therefore, the ice in the surge tank 22 may melt. At step S8, assuming such a situation, the reference amount Wsx is set based on the premise of the condensate water being in liquid phase.

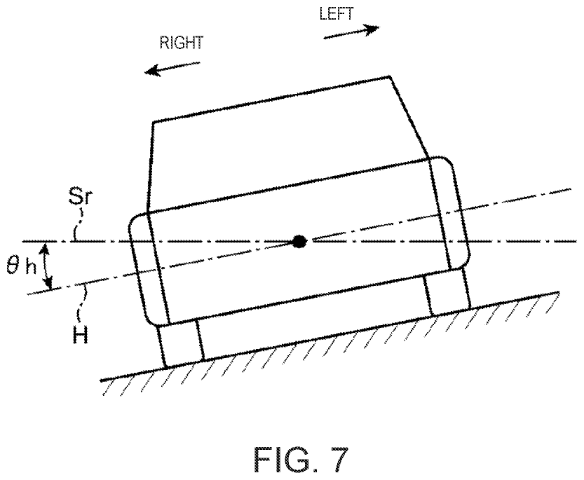

If determined to be YES at step S8 where the condensate water amount Ws is above the reference amount Wsx, the PCM 50 determines whether the vehicle stops in the rightwardly-declined state (step S9). In detail, the PCM 50 identifies an inclination angle θh in the left-and-right direction of the vehicle (vehicle width direction) illustrated in FIG. 7 based on the detection value of the tilt sensor SN7. The inclination angle θh is an angle between a reference surface Sr of the vehicle and a horizontal surface H, where the angle becomes plus or positive when the vehicle inclines so that the right side part of the vehicle becomes lower than the left side part. Then, the PCM 50 determines whether the inclination angle θh in the left and right direction described above is larger than a given plus angle defined beforehand, and if it is larger than the given angle (>0°), the PCM 50 determines that the vehicle is stopped in the rightwardly-declined state.

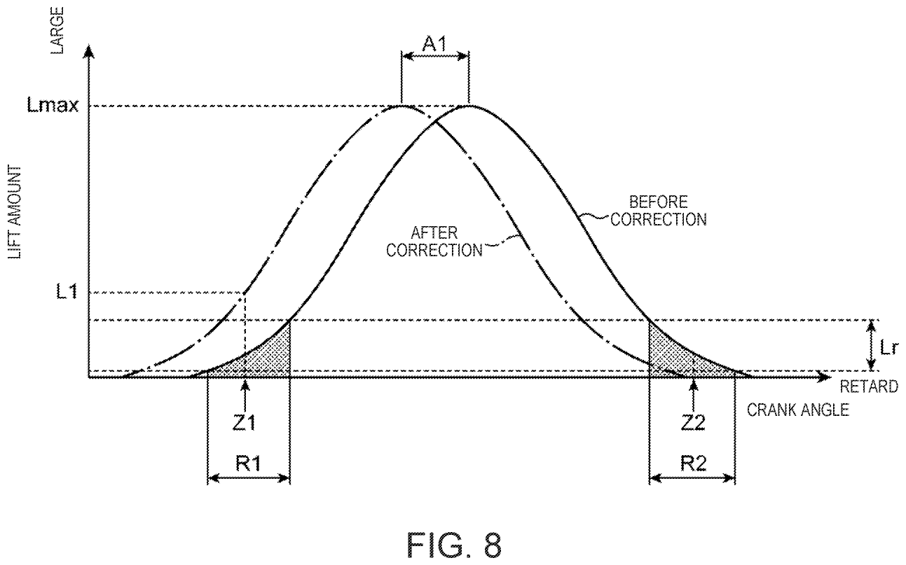

If determined to be YES at Step S9 where the vehicle is stopped in the rightwardly-declined state, the PCM 50 determines whether the intake valve 12 is in a minute opening state (step S10). In detail, the PCM 50 identifies a lift amount of the intake valve 12 of each cylinder 2 based on the detection values of the crank angle sensor SN2 and the cam angle sensor SN3. Then, the PCM 50 determines whether the lift amount of the intake valve 12 of each cylinder 2 is within a minute lift range Lr defined beforehand (see FIG. 8), and if the lift amount of the intake valve 12 of any one of the cylinders 2 is within the minute lift range Lr, the PCM 50 determines that the intake valve 12 is in the minute opening state. The lower limit of the minute lift range Lr is set slightly larger than zero. Furthermore, the upper limit of the minute lift range Lr is set sufficiently smaller than a maximum lift amount Lmax of the intake valve 12 (for example, about ¼ of Lmax).

If determined to be YES at step S10 where the intake valve 12 is in the minute opening state, in other words, all the determinations at steps S7-S10 are YES, the PCM 50 drives the intake SVT 16a to correct the phase of the intake valve 12 (the rotation phase of the camshaft for the intake valve 12 with respect to the rotation phase of the crankshaft 15) to change the lift amount of the intake valve 12 to a value deviated from the minute lift range Lr described above (step S11). In this embodiment, by correcting the phase of the intake valve 12 to an advancing side, the lift amount of the intake valve 12 is changed to the value deviated from the minute lift range Lr. For example, in the example of FIG. 8, the phase of the intake valve 12 is corrected to the advancing side by a crank angle A1. Therefore, the lift amount of the intake valve 12 is increased to a value larger than the minute lift range Lr or decreased to a value smaller than the minute lift range Lr (substantially zero).

For example, suppose that the crank angle when the engine is stopped completely is an angle Z1 included in a section R1 near an opening timing of the intake valve 12 (valve-opening start timing) of the cylinder 2 which is stopped in an intake stroke (hereinafter, it is referred to as an “intake-stroke-stopped cylinder”). In this case, if the phase of the intake valve 12 is corrected by the correction amount A1 to the advancing side, the lift amount of the intake valve 12 of the intake-stroke-stopped cylinder is increased from the value within the minute lift range Lr to a value L1 larger than the range Lr. On the contrary, suppose that the crank angle when the engine is stopped completely is an angle Z2 included in a section R2 near a closing timing of the intake valve 12 of the intake-stroke-stopped cylinder. In this case, if the phase of the intake valve 12 is corrected to the advancing side by the correction amount A1, the lift amount of the intake valve 12 of the intake-stroke-stopped cylinder is decreased from the value within the minute lift range Lr to the substantially-zero value which is smaller than the range Lr. Note that even if such a phase correction of the intake valve 12 (an advancing correction by A1) is performed, the lift amounts of the intake valves 12 of the cylinders other than the intake-stroke-stopped cylinder are maintained at zero. In other words, the correction amount A1 of the phase at step S11 is set as such a value that the lift amounts of the intake valves 12 of all the cylinders 2 are deviated from the minute lift range Lr.

Next, the PCM 50 cuts electric power supplied to the PCM 50 from a power unit (outside the drawing) to change the PCM 50 into an OFF state (step S12).

On the other hand, if any one of the determinations at steps S7-S10 is NO, the PCM 50 turns itself OFF without performing the phase correction of the intake valve 12 (step S12). Since the phase correction is not performed, the phase of the intake valve 12 in this case is maintained at the original phase which is set when the engine is stopped (i.e., the suspension reference phase suitable for the engine restart (step S5).

### (4) Operation

As described above, in this embodiment, when the engine is stopped (completely stopped), the various conditions including the condition in which the ambient temperature is below the reference temperature Tx (first condition), the condition in which the condensate water amount Ws in the surge tank 22 is above the reference amount Wsx (second condition), and the condition in which the lift amount of the intake valve 12 of any one of the cylinders 2 is within the minute lift range Lr (third condition), are determined (steps S7-S10). If all the conditions are satisfied, the phase of the intake valve 12 is corrected by the intake SVT 16a so that the lift amount of the intake valve 12 of each cylinder 2 is deviated from the minute lift range Lr. Therefore, this embodiment has an advantage that the icing of the intake valve 12 can be prevented while suppressing the influence on the engine restartability to a minimum.

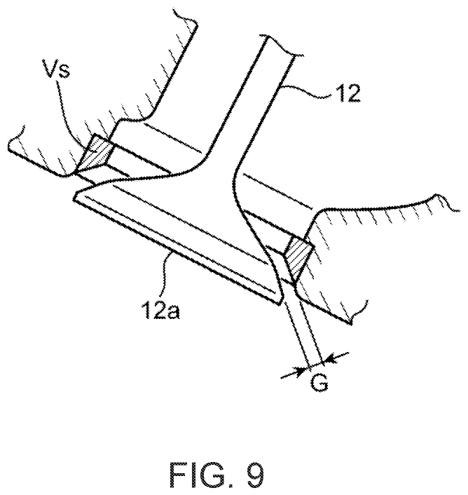

The condensate water amount Ws in the surge tank 22 being above the reference amount Wsx and the lift amount of the intake valve 12 being within the minute lift range Lr (the intake valve 12 being in the minute opening state) means that the condensate water is easy to flow from the surge tank 22 to the intake port 8, and, in addition, the flowed condensate water is easy to stagnate in a valve gap of the intake valve 12 (i.e., a valve gap G between an umbrella part 12a of the intake valve 12 and a valve seat Vs (see FIG. 9)). The small valve gap G leads to the stagnation of the condensate water because a fall of the condensate water from the valve gap G is impeded by the surface tension. Furthermore, if such a stagnation of the condensate water in the valve gap G occurs in a situation where the ambient temperature drops below the reference temperature Tx (for example, 0° C.), the possibility that the condensate water which stagnates in the valve gap G becomes frozen to form ice (the intake valve 12 freezes) becomes higher. On the other hand, in this embodiment, when the condition in which the icing of the intake valve 12 may occur, that is, when all of the three conditions comprised of (i) the ambient temperature is below the reference temperature Tx, (ii) the condensate water amount Ws in the surge tank 22 is above the reference amount Wsx, and (iii) the intake valve 12 is in the minute opening state, are satisfied, the phase of the intake valve 12 is corrected (advanced) so that the lift amount of the intake valve 12 is deviated from the minute lift range Lr. Therefore, by reducing the valve gap G to substantially zero or increasing it to the large enough value, the stagnation of the condensate water in the valve gap G can be difficult to occur and the icing of the intake valve 12 can be prevented.

For example, when the phase correction is a correction to decrease the lift amount of the intake valve 12 from the minute lift range Lr, since the valve gap G of the intake valve 12 (or the lift amount) becomes substantially zero, the condensate water which stagnated in the valve gap G is pushed out from the valve gap G and falls. On the other hand, when the phase correction is a correction to increase the lift amount of the intake valve 12 from the minute lift range Lr, the valve gap G of the intake valve 12 (or the lift amount) is increased to the large enough value, and therefore, an adsorption force of the condensate water by the surface tension weakens and the condensate water falls from the valve gap G as well. When the condensate water falls from the valve gap G, the cause of the ice formation in the valve gap G is removed, and therefore, the icing of the intake valve 12 is prevented. Thus, for example, a malfunction of the intake valve 12 occurring when the engine restarts can be prevented, to secure the suitable engine reliability.

However, when the phase of the intake valve 12 is corrected, the opening-and-closing timings of the intake valve 12 deviates from the timings suitable for the engine restart, an influence such as lengthening the time required for restarting (a time from a cranking start to a completion of combustion) may occur. On the other hand, in this embodiment, since the phase of the intake valve 12 is not corrected if at least one of the conditions (i)-(iii) described above is not satisfied, the frequency of the correction can be reduced as much as possible and the influence on the engine restartability can be suppressed to a minimum.

Furthermore, in this embodiment, in addition to the conditions (i)-(iii) described above, the condition (iv) in which the vehicle is stopped in the rightward-declining state (fourth condition) is determined (step S9), and if all of the conditions (i)-(iv) are satisfied, the phase correction of the intake valve 12 described above is performed. Therefore, it can determine in higher accuracy whether the icing of the intake valve 12 may occur, and can correct the phase of the intake valve 12 appropriately based on the determination. That is, the rightward-declining of the vehicle is such an inclination that the surge tank 22 located on the left side of the vehicle is displaced upwardly with respect to the engine body 1, where the height of the bottom surface 22a (FIG. 4) of the surge tank 22 becomes higher than the intake port 8. Since such an inclination promotes the outflow of the condensate water from the surge tank 22 to the intake port 8, it increases the possibility of icing of the intake valve 12. On the contrary, the possibility of icing becomes lower if the vehicle is not declined to the right. In this embodiment, the rightward-declination of the vehicle is also determined, and if the vehicle is not declined to the right, the phase correction of the intake valve 12 is not performed. Therefore, an unnecessary correction of the phase of the intake valve 12 in the situation where the icing of the intake valve 12 does not take place can be highly-possibly avoided. Thus, the frequency of the correction can be lessened, and the influence on the engine restartability can be minimized.

Since in this embodiment the condensate water amount Ws in the surge tank 22 described above is calculated by the given calculation in consideration of the moisture in the blowby gas being supplied to the surge tank 22, the amount of blowby-gas-originated condensate water accumulated in the surge tank 22 can be estimated exactly as the condensate water amount Ws.

That is, in this embodiment, since the engine body 1 (crankcase K) is connected with the surge tank 22 via the blowby gas passage 40, the condensate water amount Ws in the surge tank 22 is considered to be mainly originated from steam in the blowby gas introduced into the surge tank 22 through the blowby gas passage 40. Thus, in this embodiment, the condensate water amount Ws in the surge tank 22 is estimated by the given calculation in consideration of such a situation (steps S1 and S2). In detail, the oil-pan water amount Wp which is the amount of condensate water contained in the engine oil Q in the oil pan 5 is calculated based on the engine operating state, etc., the water evaporating amount w2 which is the amount of moisture which evaporates from the engine oil Q per unit time is then calculated based on the calculated oil-pan water amount Wp, and the water freezing amount w3 which is the amount of water which freezes in the surge tank 22 per unit time is then calculated based on the calculated water evaporating amount w2. Then, by integrating the water freezing amounts w3, the amount of condensate water accumulated in the surge tank 22 as ice is calculated as the condensate water amount Ws. According to such a configuration, the condensate water amount Ws in the surge tank 22 can be calculated with high accuracy by the suitable calculation technique in consideration of the actual mechanism of the condensate water being accumulated in the surge tank 22.

### (5) Modifications

In the above embodiment, the lift amount of the intake valve 12 of each cylinder 2 is determined when the engine is stopped (completely stopped), and if the lift amount of the intake valve 12 of any one of cylinders 2 is within the minute lift range Lr, the phase of the intake valve 12 is corrected to the advancing side by the given amount (such an amount that the lift amount is deviated from the minute lift range Lr). However, the correction of the phase of the intake valve 12 is not limited as long as the lift amounts of the intake valves 12 of all the cylinders 2 are deviated from the minute lift range Lr, and in this sense, it may be corrected to either the advancing side or retarding side.

Alternatively, instead of the method of this embodiment which corrects the phase of the intake valve after the engine is stopped (completely stopped), the phase of the intake valve may be adjusted during an engine stop operation (from the ignition OFF to the complete stop of the engine). That is, the lift amount of the intake valve 12 at the stop timing may be estimated during the period from the ignition OFF to the complete stop of the engine, and if the lift amount of the intake valve 12 of any one of the cylinders 2 is anticipated to be within the minute lift range Lr, the intake SVT 16a may be driven to advance or retard the phase of the intake valve 12.

In the above embodiment, the example in which the control device of the present disclosure is applied to the engine disposed in the engine bay EB of the vehicle in the longitudinal posture (the posture in which the plurality of cylinders 2 are lined up in the vehicle front-and-rear direction). However, the control device of the present disclosure may be applied not only to the longitudinal engine but also to a transverse engine (an engine disposed in a posture in which a plurality of cylinders are lined up in the vehicle width direction). In this case, since the intake passage is connected to a front or rear side surface of the engine body, when the vehicle is declined rearwardly or forwardly, the surge tank is inclined upwardly to promote an outflow of the condensate water from the surge tank to the intake port. For example, suppose that the intake passage is connected to the front side surface of the engine body, when the vehicle is declined rearwardly (such an inclination that the rear part of the vehicle becomes lower than the front part), the surge tank becomes relatively higher and the outflow of the condensate water from the surge tank to the intake port takes place easily. Thus, as for the vehicle mounted with such an engine, the rearward-declination of the vehicle may be determined, instead of the determination at step S9 of FIG. 6.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

### DESCRIPTION OF REFERENCE CHARACTERS

1: Engine

2: Cylinder

5: Oil Pan

8: Intake Port

12: Intake Valve

16a: Intake SVT (Phase Changer)

21: Independent Intake Passage

22: Surge Tank

40: Blowby Gas Passage

50: PCM (Controller)

C: Combustion Chamber

K: Crankcase

Lr: Minute Lift Range

P: Engine Oil

Wsx: Reference Amount

SN4: Intake Air Temperature Sensor (Ambient Temperature Sensor)

Tx: Reference Temperature

What is claimed is:

1. A control device configured to control an engine mounted on a vehicle, the engine provided with an engine body including a plurality of cylinders, a plurality of independent intake passages, each connected to the engine body so as to communicate with a combustion chamber of each of the cylinders via an intake port, and a surge tank connected to an upstream end of each of the independent intake passages, the control device comprising:
a phase changer configured to change a phase of an intake valve configured to open and close the intake port of each of the cylinders;
an ambient temperature sensor configured to acquire an ambient temperature; and
a controller configured to control operation of the phase changer and acquire an amount of condensate water existing in the surge tank,
wherein when the engine is stopped in a situation where both of a first condition in which the ambient temperature acquired by the ambient temperature sensor is lower than a given reference temperature and a second condition in which the amount of condensate water in the surge tank acquired by the controller is above a given reference amount are satisfied, the controller controls the phase changer so that a lift amount of the intake valve in each of the cylinders of the stopped engine becomes outside a given minute lift range.

2. The control device of claim 1, wherein when the engine is stopped, the controller determines the first and second conditions, and determines a third condition in which the lift amount of the intake valve of any one of the cylinders is within the minute lift range, and when all the first to third conditions are satisfied, the controller drives the phase changer to correct the phase of the intake valve to an advancing or retarding side so that the lift amount of the intake valve is deviated from the minute lift range in all the cylinders.

3. The control device of claim 2, wherein when the engine is stopped, the controller determines the first to third conditions, and determines a fourth condition in which the vehicle is stopped in a state where the vehicle is inclined so that the surge tank is displaced upwardly, and when all the first to fourth conditions are satisfied, the controller corrects the intake valve by the phase changer.

4. The control device of claim 3,
wherein the engine is provided with a blowby gas passage connecting the engine body to the surge tank so that blowby gas leaked to a crankcase of the engine body flows back to the surge tank, and
wherein controller estimates an oil-pan water amount that is an amount of condensate water contained in engine oil stored in an oil pan of the engine body, based on an operating state of the engine, estimates a water evaporating amount that is an amount of moisture evaporating from the engine oil, based on the estimated oil-pan water amount, and further estimates the amount of condensate water in the surge tank based on the estimated water evaporating amount.

5. The control device of claim 1,
wherein the engine is provided with a blowby gas passage connecting the engine body to the surge tank so that blowby gas leaked to a crankcase of the engine body flows back to the surge tank, and
wherein the controller estimates an oil-pan water amount that is an amount of condensate water contained in engine oil stored in an oil pan of the engine body, based on an operating state of the engine, estimates a water evaporating amount that is an amount of moisture evaporating from the engine oil, based on the estimated oil-pan water amount, and further estimates the amount of condensate water in the surge tank based on the estimated water evaporating amount.

6. The control device of claim 2,
wherein the engine is provided with a blowby gas passage connecting the engine body to the surge tank so that blowby gas leaked to a crankcase of the engine body flows back to the surge tank, and
wherein the controller estimates an oil-pan water amount that is an amount of condensate water contained in engine oil stored in an oil pan of the engine body, based on an operating state of the engine, estimates a water evaporating amount that is an amount of moisture evaporating from the engine oil, based on the estimated oil-pan water amount, and further estimates the amount of condensate water in the surge tank based on the estimated water evaporating amount.

7. The control device of claim 1, wherein a lower limit of the minute lift range is set to a value larger than zero and an upper limit of the minute lift range is set to a value smaller than a maximum lift amount of the intake valve.

8. The control device of claim 1, wherein when a crank angle while the engine is stopped completely is an angle included in a given section near an opening timing of the intake valve of an intake-stroke-stopped cylinder that is stopped in an intake stroke, the controller corrects the phase of the intake valve to an advancing side by a given correction amount to increase the lift amount of the intake valve of the intake-stroke-stopped cylinder to a value larger than the minute lift range.

9. The control device of claim 1, wherein when the crank angle while the engine is stopped completely is a given angle included in a given section near a closing timing of the intake valve of an intake-stroke-stopped cylinder that is stopped in an intake stroke, the controller corrects the phase of the intake valve to an advancing side by a given correction amount to decrease the lift amount of the intake valve of the intake-stroke-stopped cylinder to a substantially-zero value smaller than the minute lift range.

10. The control device of claim 4,
wherein the water evaporating amount is calculated based on the oil-pan water amount obtained in the previous operation cycle, and a temperature of the engine oil, and
wherein the water evaporating amount is calculated to be larger as the previous oil-pan water amount increases and calculated to be larger as the oil temperature increases.

11. The control device of claim 5,
wherein the water evaporating amount is calculated based on the oil-pan water amount obtained in the previous operation cycle, and a temperature of the engine oil, and
wherein the water evaporating amount is calculated to be larger as the previous oil pan water amount increases and calculated to be larger as the oil temperature increases.

12. The control device of claim 6,
wherein the water evaporating amount is calculated based on the oil-pan water amount obtained in the previous operation cycle, and a temperature of the engine oil, and
wherein the water evaporating amount is calculated to be larger as the previous oil-pan water amount increases and calculated to be larger as the oil temperature increases.
